(19) United States
(12) Patent Application Publication
(10) Pub. No.: US 2001/0047825 A1
(43) Pub. Date: Dec. 6, 2001

(54) Pressure flow stop

(76) Inventor: Joe L. Williams, Derry, LA (US)

Correspondence Address: John M. Harrison, 2139 E. Bert Kouns, Shreveport, LA, 71105, US

(21) Appl. No.: 09/866,429

(22) Filed: May 29, 2001

Related U.S. Application Data
(63) Continuation-in-part of application No. 09/576,283, filed on May 23, 2000, now Pat. No. 6,263,896.

(51) Int. Cl. F16K 43/00

(52) U.S. Cl. 137/315.06

(57) ABSTRACT

A pressure flow stop which can be used for temporarily blocking flow of water from a main water supply line to a residence or business in order to facilitate replacement of a damaged, defective or deteriorated water shutoff valve, or “curbstop”, at the residence or business. The pressure flow stop may include an elongated shaft housing which is removably attached to the damaged, defective or deteriorated water shutoff valve after the water shutoff valve is closed and the water meter is removed from the water shutoff valve, respectively. An elongated inflation shaft, terminated by an inflatable balloon, is slidably disposed in the shaft housing, and the water shutoff valve is opened to facilitate extension of the balloon end of the inflation shaft from the shaft housing, through the water shutoff valve and into the water source pipe leading from the main water line. The balloon is inflated to obstruct the water source pipe and block further flow of water from the pipe into the water shutoff valve as the water shutoff valve is detached from the pipe and removed from over the inflation shaft and as a replacement water shutoff valve is slipped over the inflation shaft and replaced on the pipe. Finally, the balloon is deflated and removed from the pipe and replacement water shutoff valve, the replacement water shutoff valve is closed, the water meter is threaded on the replacement water shutoff valve and the replacement water shutoff valve is opened, respectively, to resume flow of water from the main water line to the residence or business.

### CROSS-REFERENCE TO RELATED APPLICATIONS

This is a continuation-in-part of my U.S. patent application Ser. No. 09/576,283, filed May 23, 2000.

### BACKGROUND OF THE INVENTION

### Field of the Invention

This invention relates to a water shutoff valve or “curbstop” changing apparatus and more particularly, to an apparatus which is suitably adapted to temporarily block flow of water through a water shutoff valve of a residence or business in order to facilitate replacing the damaged, deteriorated or defective water shutoff valve, without requiring termination of water flow through the main water line. Accordingly, water service interruption is limited to the residence or business having the damaged, deteriorated or defective water shutoff valve, while water service to the remaining residences or businesses served by the main water line continues during replacement of the valve. The pressure flow stop of this invention may include an elongated shaft housing and an elongated inflation shaft slidably disposed in the shaft housing, which inflation shaft is removably and pneumatically coupled to a balloon stem terminated by an inflatable balloon. In typical application of the pressure flow stop, the water shutoff valve to be replaced is closed, the water meter is unthreaded from the water shutoff valve and the shaft housing is threaded on the water shutoff valve in place of the water meter. The water shutoff valve is opened to facilitate extension of the balloon and inflation shaft from the housing through the water shutoff valve and into the water source pipe leading from the main water line. The balloon is inflated to obstruct the water source pipe and block further flow of water from the pipe into the water shutoff valve. While the water source pipe remains obstructed, the shaft housing is unthreaded from the water shutoff valve, the inflation shaft is uncoupled from the balloon stem, the water shutoff valve is unthreaded from the pipe and slipped over the inflation shaft, a replacement water shutoff valve is slipped over the inflation shaft and threaded on the pipe, the shaft housing is threaded on the replacement water shutoff valve and the inflation shaft is again coupled to the balloon stem After the balloon is deflated, the balloon and inflation shaft are removed from the replacement water shutoff valve, the replacement water shutoff valve is closed and the shaft housing is unthreaded from the replacement water shutoff valve. Finally, the water meter is threaded on the replacement water shutoff valve and the replacement water shutoff valve is opened to resume flow of water from the main water line to the residence or business.

Modern conventional water systems typically interconnect the water piping systems of multiple residences or businesses. In order to replace a damaged, deteriorated or defective water shutoff valve, commonly known as a “curbstop”, of one of the residences or businesses, the main water line which serves all of the residences or businesses in the system must typically be crimped, frozen or shut off during the replacement operation. However, these conventional techniques may damage the water line, require expensive machinery and refrigerants and shut off the water supply to all of the residences or businesses served by the main water line.

Accordingly, an object of this invention is to provide a pressure flow stop which is suitably adapted for temporarily blocking flow of water through the water shutoff valve of a residence or business, in order to facilitate replacement of the valve.

Another object of this invention is to provide an apparatus which is adapted to temporarily terminate flow of water through a water shutoff valve of a residence or business in a water distribution system in order to facilitate replacing the damaged, deteriorated or defective water shutoff valve without requiring termination of waterflow through the main water line and interruption of water supply to other residences or businesses served by the water distribution system.

Still another object of this invention is to provide a pressure flow stop for temporarily blocking flow of water through a water shutoff valve of a residence or business in order to facilitate replacing the valve, which pressure flow stop is characterized by an elongated housing which is removably attached to the water shutoff valve after the water meter is removed from the valve; and an elongated inflation shaft terminated by an inflatable balloon which is slidably disposed in the housing, wherein the balloon and inflation shaft are extended from the housing and through the open water shutoff valve and positioned in a water source line to which the water shutoff valve is attached, and the balloon is inflated on the shaft to obstruct the water source line or pipe and substantially block flow of water from the water source line to the water shutoff valve to facilitate replacement of the valve.

Yet another object of this invention is to provide a pressure flow stop for temporarily blocking flow of water from a main water supply line to a residence or business in order to facilitate replacement of a damaged, defective or deteriorated water shutoff valve of the residence or business, which pressure flow stop may include an elongated shaft housing which is initially removably threaded on the damaged, defective or deteriorated water shutoff valve after the water shutoff valve is closed and the water meter is unthreaded from the water shutoff valve; and an elongated inflation shaft which is terminated by an inflatable balloon and is sidably disposed in the shaft housing. The shutoff valve is opened to facilitate extension of the inflation shaft and balloon from the attached shaft housing, through the open water shutoff valve and into the water source line which extends from the main water line. The balloon is then selectively inflated to obstruct the interior of the water source line and block further flow of water from the main water line into the water shutoff valve. The water shutoff valve is detached from the balloon-obstructed water source line and slipped over the inflation shaft, and a replacement water shutoff valve is slipped over the inflation shaft and replaced on the water source line. The shaft housing is threaded on the replacement water shutoff valve as the inflated balloon continues to obstruct the water source line, and the balloon is deflated and the inflation shaft and deflated balloon are removed from the water source line and replacement water shutoff valve. After the replacement water shutoff valve is closed and the shaft housing is unthreaded from the replacement water shutoff valve, the water meter is threaded on the replacement water shutoff valve and the water shutoff valve is opened, respectively, to resume flow of water from the water source line to the residence or business.

A still further object of this invention is to provide a method of replacing a damaged, deteriorated or defective water shutoff valve or “curbstop” of a residence or business without requiring termination of water service to the other residences or businesses with which the water shutoff valve is connected.

### SUMMARY OF THE INVENTION

These and other objects of the invention are provided in a pressure flow stop which can be used to temporarily block flow of water through a damaged, deteriorated or defective water shutoff valve of a residence or business, in order to facilitate replacing the water shutoff valve without requiring termination of water flow in the main water line and interrupting water distribution to other residences or businesses served by the main water line. The pressure flow stop of this invention may include an elongated shaft housing and an elongated inflation shaft slidably disposed in the shaft housing and pneumatically coupled to a balloon stem that is terminated by an inflatable balloon. In typical application of the pressure flow stop, the water shutoff valve to be replaced is closed, the water meter is unthreaded from the water shutoff valve and the shaft housing is threaded on the water shutoff valve in place of the water meter. The water shutoff valve is opened to facilitate extension of the balloon and inflation shaft from the shaft housing, through the water shutoff valve and into the water source pipe leading from the main water line. The balloon is inflated to obstruct the water source pipe and block further flow of water from the pipe into the water shutoff valve. While the water source pipe remains obstructed by the balloon, the shaft housing is unthreaded from the water shutoff valve, the inflation shaft is uncoupled from the balloon stem, the water shutoff valve is unthreaded from the pipe and slipped over the balloon stem, a replacement water shutoff valve is slipped over the balloon stem and threaded on the pipe, the shaft housing is threaded on the replacement water shutoff valve and the inflation shaft is again coupled to the balloon stem. The balloon is deflated in the water source pipe, the inflation shaft, balloon stem and balloon are removed from the water source pipe and replacement water shutoff valve, and the replacement water shutoff valve is closed. Finally, the shaft housing is replaced by the water meter on the replacement water shutoff valve and the replacement water shutoff valve is opened to resume flow of water from the main water line to the residence or business.

### BRIEF DESCRIPTION OF THE DRAWINGS

The invention will be better understood by reference to the accompanying drawings, wherein:

FIG. 1 is a perspective view of an illustrative embodiment of the pressure flow stop of this invention, removably attached to a water shutoff valve connected to a horizontal water source pipe, both illustrated in phantom, in typical application of the pressure flow stop;

FIG. 2 is a perspective view of the pressure flow stop illustrated in FIG. 1, removed from the water shutoff valve (not illustrated);

FIG. 3 is a perspective view of the inflation shaft component of the pressure flow stop, removed from the shaft housing;

FIG. 4 is a perspective view of the balloon stem and balloon components of the pressure flow stop, with the the balloon stem uncoupled from the inflation shaft illustrated in FIG. 3;

FIG. 5 is a longitudinal sectional view of the shaft housing component of the pressure flow stop, shown removably threaded on a damaged, deteriorated or defective water shutoff valve, illustrated in phantom, and the deflated balloon of the pressure flow stop extending from the shaft housing, prior to advancing the balloon through the water shutoff valve and into a horizontal water source pipe (in phantom), connected to the water shutoff valve, in typical application of the pressure flow stop;

FIG. 6 is a longitudinal sectional view of the shaft housing component of the pressure flow stop illustrated in FIG. 5, with the balloon stem component of the pressure flow stop extending through the water shutoff valve (in phantom) and the balloon component of the pressure flow stop shown inflated and obstructing the horizontal water source pipe (in phantom), connected to the water shutoff valve;

FIG. 7 is a longitudinal sectional view of the water shutoff valve and water source pipe (in phantom) illustrated in FIGS. 5 and 6, with the inflation shaft component of the pressure flow stop uncoupled from the balloon stem component of the pressure flow stop, and the balloon stem extending through the damaged, defective or deteriorated water shutoff valve and the inflated balloon of the pressure flow stop, attached to the balloon stem, obstructing the horizontal water source pipe prior to removing the water shutoff valve from the water source pipe;

FIG. 8 is a longitudinal sectional view of the water source pipe illustrated in FIG. 7, illustrated in phantom, with the damaged, defective or deteriorated water shutoff valve (not illustrated) removed from the water source pipe and the inflated balloon of the pressure flow stop remaining in obstructing configuration in the water source pipe, after removal of the water shutoff valve from the water source pipe and prior to mounting a replacement water shutoff valve on the water source pipe;

FIG. 9 is a longitudinal sectional view of the shaft housing component of the pressure flow stop, connected to an L-shaped damaged, defective or deteriorated water shutoff valve, illustrated in phantom, with the inflation shaft of the pressure flow stop extending through the shaft housing and water shutoff valve and the inflated balloon of the pressure flow stop obstructing a vertical water source pipe (illustrated in phantom), connected to the water shutoff valve;

FIG. 10 is a longitudinal sectional view of the water shutoff valve and water source pipe illustrated in FIG. 9, with the balloon stem component of the pressure flow stop extending through the water shutoff valve and the inflated balloon of the pressure flow stop remaining in obstructing configuration in the water source pipe, after removal of the shaft housing from the water shutoff valve and uncoupling of the inflation shaft from the balloon stem prior to removing the water shutoff valve from the water source pipe;

FIG. 11 is a longitudinal sectional view of the vertical water source pipe illustrated in FIGS. 9 and 10, illustrated in phantom, with the inflated balloon of the pressure flow stop remaining in obstructing configuration in the water source pipe prior to mounting a replacement water shutoff valve on the water source pipe;

FIG. 12 is an exploded, perspective view of the inflation shaft component, partially in section, of the pressure flow stop, with a gland nut provided on the inflation shaft and illustrating seating of a pair of O-rings in respective O-ring grooves provided in the gland nut and;

FIG. 13 is a side view, partially in section, of the inflation stem and gland nut illustrated in FIG. 12.

### DESCRIPTION OF THE PREFERRED EMBODIMENTS

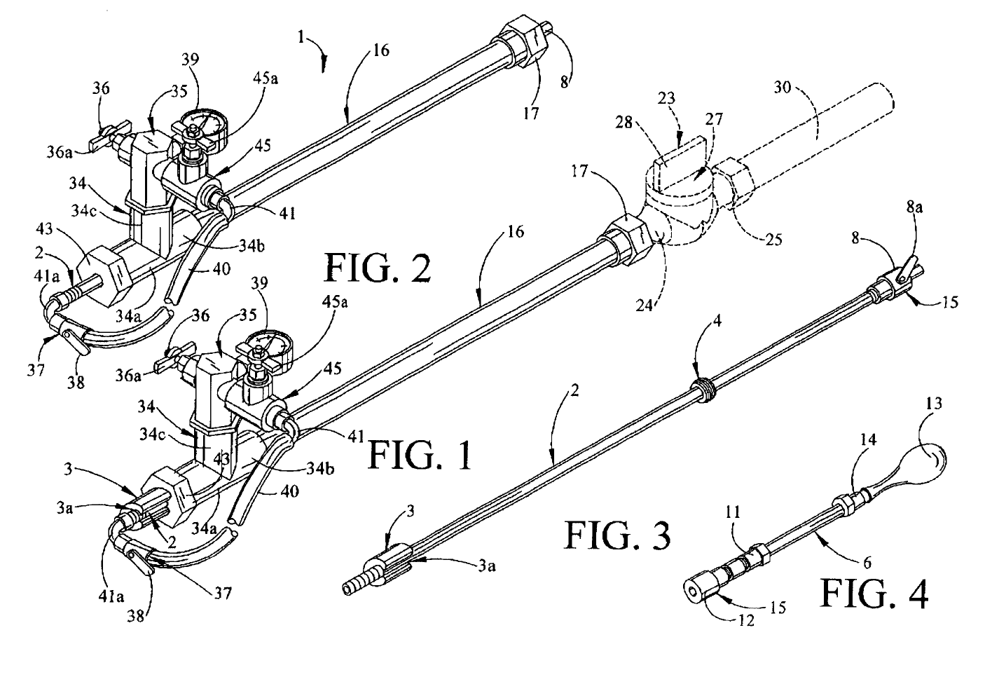

Referring initially to FIGS. 1 and 9 of the drawings, a conventional water shutoff valve 23 (illustrated in phantom in FIGS. 1 and 9), commonly known as a “curbstop”, typically includes a straight valve housing 27, as illustrated in FIG. 1, or a generally L-shaped valve housing 27, as illustrated in FIG. 9. The valve housing 27 is fitted with a valve 28. A water meter (not illustrated) is typically threadibly attached to a water meter coupling 24 of the valve housing 27, and a water line coupling 25 of the valve housing 27 is threaded in fluid communication with a water source pipe 30 (illustrated in phantom in FIGS. 1 and 9), connected to a main water line (not illustrated). A constant supply of water is normally distributed from the main water line to each of multiple residences or businesses, through the water source line 30, valve housing 27, open valve 28 of the water shutoff valve 23, and connected water meter, and into a water service pipe (not illustrated) which distributes the water to the residence or business. When it becomes necessary to replace a damaged, defective or deteriorated water shutoff valve 23 of one of the residences or businesses served by the main water line typically due to leakage of the valve 28, water flow to all of the residences or businesses typically is temporarily terminated by means of crimping or freezing the main water line, or otherwise terminating water flow through the water line. The pressure flow stop of this invention, generally illustrated by reference numeral 1, is designed to temporarily terminate water flow from the water source pipe 30 to the water shutoff valve 23 in order to facilitate replacement of the water shutoff valve 23. Accordingly, termination of water flow in the main water line and interruption of water service to other residences or businesses served by the main water line is unnecessary.

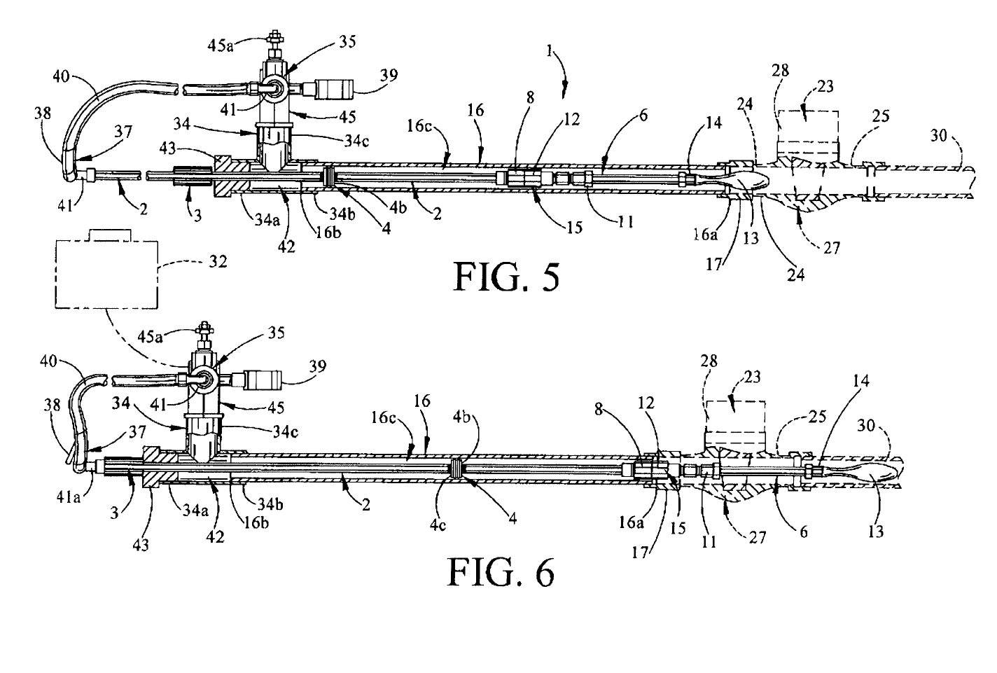

Referring next to FIGS. 1-6, 12 and 13 of the drawings, the pressure flow stop 1 of this invention includes an elongated, rigid, tubular inflation shaft 2, typically constructed of steel aluminum or brass, in non-exclusive particular. An O-ring collar 4, provided with a pair of adjacent O-ring grooves 4a, as illustrated in FIGS. 12 and 13, is mounted on the inflation shaft 2, and a pair of 0-rings 5 is seated in the respective O-ring grooves 4a, in spaced-apart relationship with respect to each other. As illustrated in FIG. 3, the front end of the inflation shaft 2 terminates in pneumatic communication with a male element 8 of a split-housing check valve 15, fitted with a lock tab 8a. In application of the pressure flow stop 1 as hereinafter further described, the male element 8 of the split-housing check valve 15 is removably inserted in a companion female element 12 of the split-housing check valve 15, fitted in pneumatic communication with a flexible, typically plastic, jointed metal or rubber, tubular balloon stem 6 typically by means of a compression fitting 11, as illustrated in FIG. 4. Accordingly, when the male element 8 is coupled to the female element 12 of the check valve 15, the check valve 15 allows bidirectional flow of air between the inflation shaft 2 and the balloon stem 6, whereas the female element 12 prevents backflow of air from the balloon stem 6 through the female element 12 of the check valve 15 when the male element 8 is uncoupled from the female element 12 of the check valve 15, as hereinafter described. A rubber balloon 13 is fitted on the front end of the balloon stem 6, in pneumatic communication therewith typically by means of a compression fitting 14. The inflation shaft 2 and balloon stem 6 of the pressure flow stop 1 are slidably mounted in the housing interior 16c of an elongated, typically cylindrical shaft housing 16, typically constructed of polyvinyl chloride (PVC). A typically ¾″ threaded, hex-headed coupling cap 17 is slidably mounted on the front end 16a portion of the shaft housing 16 for threadibly engaging the companion water meter coupling 24 (illustrated in phantom in FIG. 1) of the valve housing 27, in application of the pressure flow stop 1 as hereinafter described. As illustrated in FIG. 5, the front arm 34b of a housing T-fitting 34, having a rear arm 34a, a middle arm 34c and a T-fitting interior 42, receives the rear end 16b of the shaft housing 16, the purpose of which housing T-fitting 34 will be hereinafter described. As further illustrated in FIG. 5, an insert 43, having a central shaft opening (not illustrated), is inserted in the rear arm 34a of the housing T-fitting 34, and the housing shaft 2 slidably extends through the central shaft opening (not illustrated) of the insert 43. A valve body 35 is provided on the upward-standing middle arm 34c of the housing T-fitting 34, in pneumatic communication with the T-fitting interior 42. As illustrated in FIGS. 1 and 2, a flow valve 45, provided with a flow valve handle 45a, extends from the valve body 35, and a stem valve 36, fitted with a stem valve handle 36a, further extends from the valve body 35, opposite the flow valve 45. The valve body 35 is typically provided with an air pressure indicator dial 39 to indicate the pressure of air flowing from the stem valve 36 through the valve body 35, as hereinafter further described. Hose connectors 41 and 41a extend from the flow valve 45 and from the rear end of the inflation shaft 2, respectively, as illustrated in FIGS. 1 and 2, and a pneumatic hose 40 establishes pneumatic communication between the flow valve 45 and the inflation valve 37, through the respective hose connectors 41 and 41a. An inflation valve 37, fitted with an inflation valve handle 38, is mounted in the pneumatic hose 40, adjacent to the hose connector 41a. Accordingly, as illustrated in FIG. 6, an air pump 32 can be coupled to the stem valve 36 to facilitate flow of air through the valve body 35 and into the T-fitting interior 42 of the housing T-fitting 34 and into the housing interior 16c of the shaft housing 16, where the pressure of the flowing air impinges against the rear face 4c of the O-ring collar 4 to slide the inflation shaft 2 forwardly in the housing interior 16c and advance the balloon 13 through the water shutoff valve 23 and into the water source pipe 30, in typical application of the pressure flow stop 1 as hereinafter farther described. In that case, a cylindrical lock sleeve 3, traversed by a longitudinal shaft groove 3a, may be fitted on the inflation shaft 2 between the insert 43 of the housing T-fitting and the hose connector 41 on the inflation shaft 2 to space the hose connector 41 from the insert 43 and limit the depth of insertion of the balloon 13 in the water source pipe 30, as hereinafter further described. Alternatively, upon opening of the inflation valve 37 by selective operation of the inflation valve handle 38, air flows from the air pump 32, through the stem valve 36, the valve body 35, the flow valve 45, the pneumatic hose 40, the inflation valve 37 and finally, through the balloon stem 6 and into the balloon 13 to inflate the balloon 13, which blocks the water source pipe 30 against water flow through the water shutoff valve 23.

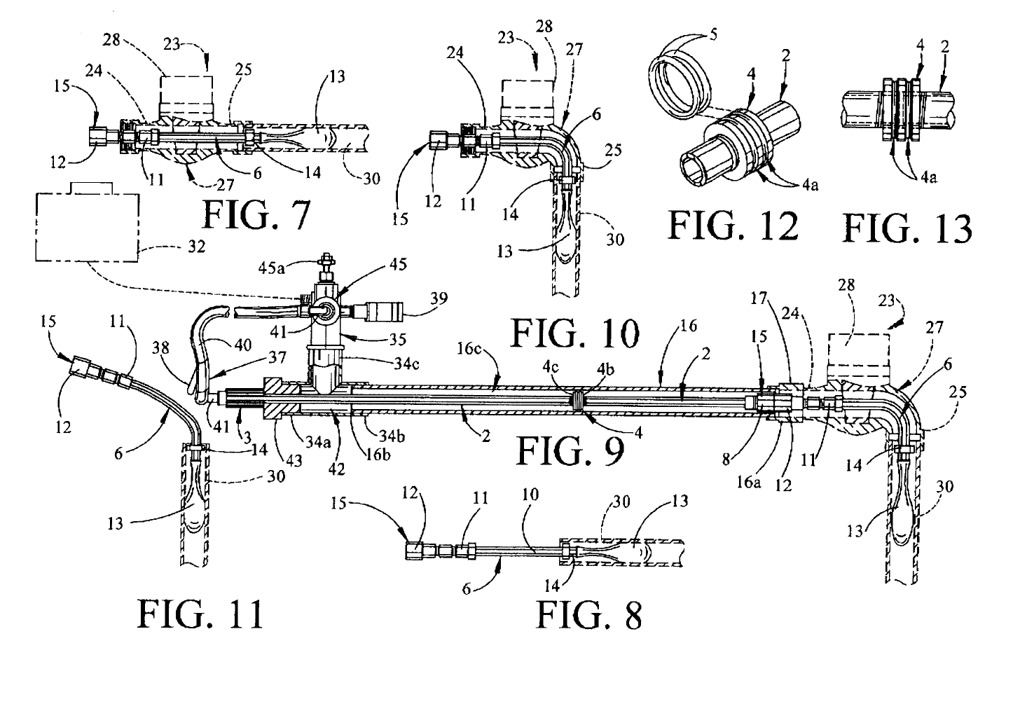

Referring again to FIGS. 1 and 5 and to FIGS. 6-11 of the drawings, in typical application the pressure flow stop 1 of this invention is capable of temporarily blocking water flow from the water source pipe 30, attached to a main water line (not illustrated), to a damaged, defective or deteriorated water shutoff valve 23 of a business or residence, in order to facilitate replacing the water shutoff valve 23. Accordingly, the valve 28 of the water shutoff valve 23 is initially closed in order to halt flow of water from the water source pipe 30 into the water meter coupling 24 of the valve housing 27 and attached water meter (not illustrated, threadibly attached to the water meter coupling 24). The water meter is next unthreaded from the water meter coupling 24, and the threaded coupling cap 17 of the shaft housing 16 is caused to threadibly engage the water meter coupling 24, as illustrated in FIG. 1. It will be appreciated by those skilled in the art that a 1″ or other size adaptor (not illustrated) can be threaded on the typically ¾″ threaded coupling cap 17 to fit the water meter coupling 24 of the valve housing 27, as needed. It is further understood that a conventional threaded adaptor (not illustrated) can be provided on the shaft housing 16 instead of the coupling cap 17 for removably attaching the shaft housing 16 to the water meter coupling 24. The inflation valve 37 of the pressure flow stop 1 is closed by pivoting the inflation valve handle 38 to extend from the inflation valve 37, and the valve 28 of the water shutoff valve 23 is opened, such that water flows under pressure from the water source pipe 30, through the valve housing 27 of the open water shutoff valve 23 and into the housing interior 16c of the shaft housing 16, where the water pushes against the front face 4b of the O-ring collar 4 and advances the inflation shaft 2 rearwardly through the shaft opening (not illustrated) of the insert 43. With the inflation shaft 2 coupled to the balloon stem 6 at the split-housing check valve 15 and the inflation shaft 2 extended from the insert 43 of the housing T-fitting 34, as illustrated in FIG. 5, the lock sleeve 3 is fitted on the inflation shaft 2 by inserting the inflation shaft 2 in the longitudinal shaft groove 3a of the lock sleeve 3, as illustrated in FIG. 1. The air pump 32 (coupled to the pressure flow stop 1 at the stem valve 36) is operated to cause pressurized air to flow through the valve body 35, the T-fitting interior 42 of the housing T-fitting 34 and into the housing interior 16c of the shaft housing 16, where the pressurized air impinges against the rear face 4c of the O-ring collar 4 and advances the inflation shaft 2 forwardly through the housing interior 16c and slides the inflation shaft 2 forwardly through the shaft opening (not illustrated) in the insert 43 of the housing T-fitting 34. The O-rings 5, seated in the O-ring grooves 4a (FIG. 13) of the O-ring collar 4, form a water-tight seal between the T-fitting interior 42 and the open valve 28 of the water shutoff valve 23, as illustrated in FIG. 5. The pressurized air in the housing interior 16c continues forward advancement of the inflation shaft 2 in the housing interior 16c until the deflated balloon 13 traverses the valve housing 27 of the open water shutoff valve 23 and finally, enters the water source pipe 30 as illustrated in FIG. 6. Advancement of the balloon 13 in the water source pipe 30 is halted when the lock sleeve 3, fitted on the inflation shaft 2 at the shaft groove 3a (FIG. 1) as heretofore described, becomes interposed between the hose connector 41a at the rear end of the inflation shaft 2 and the rear end of the insert 43 of the housing T-fitting 34. In the case of the L-shaped valve housing 27 illustrated in FIG. 9, the flexible balloon stem 6 bends downwardly and enters the water line coupling 25 of the valve housing 27 as the advancing balloon 13 engages the water line coupling 25 interior. As the deflated balloon 13 advances from the housing interior 16c of the shaft housing 16, through the valve housing 27 and into the water source line 30, pressurized water flows from the water source fine 30, through the valve housing 27 of the open water shutoff valve 23 and into the housing interior 16c of the attached shaft housing 16, and is prevented from flowing past the O-ring collar 4 by operation of both O-rings 4 of the O-ring collar 4, located between the water shutoff valve 23 and T-fitting interior 42 of the housing T-fitting 34 as illustrated in FIGS. 5 and 6. It will be appreciated by those skilled in the art that the air pressure exerted against the rear face 4c of the O-ring collar 4 in the housing interior 16c of the shaft housing 16 overcomes the opposing water pressure against the front face 4b of the O-ring collar 4 to facilitate forward advancement of the inflation shaft 2 agape the water pressure. It will be further appreciated by those skilled in the art that the rigid inflation shaft 2 reinforces the flexible balloon stem 6 against water pressure as the balloon stem 6 is advanced through the valve housing 27 and water source pipe 30 and pressurized water flows from the valve housing 27 into the housing interior 16c of the shaft housing 16. Once it is positioned in the water source pipe 30 as illustrated in FIGS. 6 and 9, the balloon 13 is inflated by opening the inflation valve 37 by pivoting the inflation valve handle 38 to lie flat against the inflation valve 37. This causes pressurized air from the air pump 32 to flow through the flow valve 45, pneumatic hose 40, open inflation valve 37, inflation shaft 2, balloon stem 6 and finally, into the balloon 13, since the air pressure in the alternative air flow pathway provided by the T-fitting interior 42 and housing interior 16c, due to the stationary position of the O-ring collar 4 in the housing interior 16c, imparted by the lock sleeve 3, exceeds the air pressure in the pneumatic hose 40, inflation shaft 2, balloon stem 6 and balloon 13. The balloon 13 continues to inflate until the inflating balloon 13 substantially obstructs the interior of the water source pipe 30 and blocks further flow of pressurized water from the main water line and water source pipe 30, into the valve housing 27 of the open water shutoff valve 23. While the inflated balloon 13 remains lodged in the water source pipe 30, the inflation valve 37 is closed by extending the inflation valve handle 38 from the inflation valve 37, and this action terminates inflation of the balloon 13 in the water source pipe 30. The shaft housing 16 is next unthreaded from the valve housing 27 at the coupling cap 17 and the inflation shaft 2 is uncoupled from the balloon stem 6 by lifting the lock tab 8a (FIG. 3) of the male element 8 of the split-housing check valve 15 and removing the male element 8 from the female element 12 of the split-housing check valve 15. Consequently, the female element 12 of the split-housing check valve 15 pneumatically seals the balloon stem 6 such that the balloon 13 remains inflated and sealed in the water source pipe 30, as illustrated in FIGS. 7 and 10. The damaged, deteriorated or defective water shutoff valve 23 is unthreaded from the water source pipe 30 and pulled from the check valve 15 end of the balloon stem 6 as the balloon 13 remains inflated in the water source pipe 30, as illustrated in FIGS. 8 and 11. As the water source pipe 30 remains obstructed by the inflated balloon 13, a replacement water shutoff valve 23 is slipped on the check valve 15 end of the balloon stem 6 by inserting the female element 12 of the split housing check valve 15 in the water line coupling 25 and out of the water meter coupling 24 of the replacement water shutoff valve 23, as the replacement water shutoff valve 23 is slided on the balloon stem 6, and the water line coupling 25 of the water shutoff valve 23 is threaded on the water source pipe 30, as illustrated in FIGS. 7 and 10. The inflation shaft 2 is again pneumatically coupled to the balloon stem 6 by inserting the male element 8 of the check valve 15 into the female element 12 of the check valve 15 and locking the lock tab 8a, and this opens the check valve 15 and enables flow of air from the balloon stem 6 into the housing shaft 2. The shaft housing 16 of the pressure flow stop 1 is next threaded on the water meter coupling 24 of the replacement shutoff valve 23, as illustrated in FIGS. 6 and 9, by operation of the coupling cap 17. After the inflation valve 37 is again opened by pivoting the inflation valve handle 38 to lie against the inflation valve 37, the balloon 13 is deflated in the water source pipe 30 by depressing the stem (not illustrated) of the pneumatic stem valve 36 (provided on the valve body 35), and this action unblocks the water source pipe 30 and allows the pressurized water in the water source pipe 30 to flow from the water source pipe 30, through the valve housing 27 of the open replacement water shutoff valve 23 and into the housing interior 16c of the shaft housing 16, where the pressurized water pushes rearwardly against the front face 4b of the O-ring collar 4 and slides the inflation shaft 2 rearwardly in the housing interior 16c. The flowing water further pushes the deflated balloon 13 from the water source pipe 30, through the open replacement water shutoff valve 23 and into the housing interior 16c of the shaft housing 16, as the inflation shaft 2 extends from the central shaft opening (not illustrated) of the insert 43. The replacement water shutoff valve 23 is next closed to prevent further flow of water from the water source pipe 30 and replacement water shutoff valve 23. Finally, the shaft housing 16 is unthreaded from the water meter coupling 24 of the replacement water shutoff valve 23, the water meter (not illustrated) is threaded on the water meter coupling 24 of the replacement water shutoff valve 23 and the valve 28 of the water shutoff valve 23 is opened, respectively, in order to re-establish flow of water from the main water line to the residence or business serviced by the water source pipe 30.

It will be appreciated by those skilled in the art that the pressure flow stop of this invention is simple in design and operation and eliminates the necessity of terminating supply of water to multiple residences or businesses served by a main water line, under circumstances in which it is necessary to replace the water shutoff valve of one of the residences or businesses served by the main water line. The pressure flow stop 1 can be constructed in a variety of sizes in order to facilitate replacement of water shutoff valves having various sizes. While the balloon stem 6 is typically constructed of flexible plastic, it is understood that it can be constructed of any elongated, water-tight tubular flexible material, including rubber or a jointed or segmented metal tube. Moreover, it is understood that any suitable pressurized fluid can be introduced into the inflation shaft 2 in order to inflate the balloon 13, according to the knowledge of those skilled in the art.

While the preferred embodiments of the invention have been described above, it will be recognized and understood that various modifications can be made in the invention and the appended claims are intended to cover all such modifications which may fall within the spirit and scope of the invention.

Having described my invention with the particularity set forth above, what is claimed is:

1. A pressure flow stop for selectively blocking flow of water through a conduit by using pressurized air to facilitate replacing a water shutoff valve on the conduit and attaching a water meter to the water shutoff valve, said pressure flow stop comprising:
a shaft housing for removable attachment to the water shutoff valve;
a first valve provided in pneumatic communication with said shaft housing for receiving the pressurized air;
an inflation shaft slidably mounted in said shaft housing;
a sealing mechanism provided on said inflation shaft and engaging said shaft housing for providing a substantially air-tight seal between said inflation shaft and said shaft housing;
a second valve provided in pneumatic communication with said first valve and said inflation shaft for selectively distributing the pressurized air between said first valve and said inflation shaft;
a balloon stem removably coupled to said inflation shaft in pneumatic communication with said inflation shaft for receiving the pressurized air from said inflation shaft;
a check valve provided on said balloon stem, said check valve disposed in an open configuration when said inflation shaft is coupled to said balloon stem to maintain pneumatic communication between said inflation shaft and said balloon stem;
wherein said check valve is disposed in a closed, air-sealing cofiguration when said inflation shaft is uncoupled from said balloon stem; and
a balloon provided in pneumatic communication with said balloon stem for location in the conduit and receiving the pressurized air from said balloon stem, said balloon and said balloon stem inserted through the water shutoff valve and said balloon positioned in the conduit by introducing the pressurized air into said first valve with said second valve closed, whereby the pressurized air flows into said shaft housing and impinges against said sealing mechanism to slidably displace said inflation shaft in said shaft housing;
wherein said balloon is inflated to block the conduit by opening said second valve, whereby the pressurized air flows through said second valve and into said inflation shaft and said balloon stem and into said balloon and said balloon inflates on said balloon stem and substantially obstructs and blocks water flow through the conduit, responsive to introducing the pressurized air into said first valve;
wherein inflation of said balloon is terminated by closing said second valve; and
wherein the water shutoff valve is replaced on the conduit by disconnecting said shaft housing from the water shutoff valve; uncoupling said inflation shaft from said balloon stem with said balloon stem extending through the water shutoff valve and said balloon obstructing the conduit, whereby said check valve closes to maintain the pressurized air in said balloon; disconnecting the water shutoff valve from the conduit and sliding the water shutoff valve over said balloon stem to remove the water shutoff valve from said balloon stem; sliding a replacement water shutoff valve over said balloon stem and connecting the replacement water shutoff valve to the conduit, whereby said balloon stem extends through the replacement water shutoff valve; re-coupling said inflation shaft to said balloon stem, whereby said check valve opens to re-establish pneumatic communication between said inflation shaft and said balloon stem; connecting said shaft housing to the replacement water shutoff valve; deflating said balloon and removing the pressurized air from said balloon stem and said inflation shaft by releasing the pressurized air from said first valve with said second valve open, whereby water in the conduit flows under pressure from the conduit, through the replacement water shutoff valve and into said shaft housing and impinges against said sealing mechanism to slide said inflation shaft in said shaft housing and withdraw said balloon from the conduit; closing the replacement water shutoff valve; disconnecting said shaft housing from the replacement water shutoff valve; attaching the water meter to the replacement water shutoff valve; and opening the replacement water shutoff valve to establish flow of water from the conduit, through the replacement water shutoff valve and to the water meter.

2. The pressure flow stop of claim 1 comprising a pneumatic hose establishing air communication between said first valve and said second valve.

3. The pressure flow stop of claim 1 comprising a valve body provided in pneumatic communication with said shaft housing and wherein said first valve is provided in pneumatic communication with said valve body.

4. The pressure flow stop of claim 3 comprising a pneumatic hose establishing air communication between said first valve and said second valve.

5. The pressure flow stop of claim 1 comprising a threaded coupling cap provided on said shaft housing for removably attaching said shaft housing to the water shutoff valve.

6. The pressure flow stop of claim 5 comprising a pneumatic hose establishing air communication between said first valve and said second valve.

7. The pressure flow stop of claim 5 comprising a valve body provided in pneumatic communication with said shaft housing and wherein said first valve is provided in pneumatic communication with said valve body.

8. The pressure flow stop of claim 7 comprising a pneumatic hose establishing air communication between said first valve and said second valve.

9. The pressure flow stop of claim 2 wherein said second valve is provided in said pneumatic hose.

10. The pressure flow stop of clam 9 comprising a valve body provided in pneumatic communication with said shaft housing and wherein said first valve is provided in pneumatic communication with said valve body.

11. The pressure flow stop of claim 9 comprising a threaded coupling cap provided on said shaft housing for removably attaching said shaft housing to the water shutoff valve.

12. The pressure flow stop of claim 11 comprising a valve body provided in pneumatic communication with said shaft housing and wherein said first valve is provided in pneumatic communication with said valve body.

13. A pressure flow stop for selectively blocking flow of water through a conduit by using pressurized air, said pressure flow stop comprising:
a first valve for receiving the pressurized air;
a shaft housing provided in pneumatic communication with said first valve for removable attachment to the conduit and receiving the pressurized air from said first valve;
an inflation shaft slidably mounted in said shaft housing;
a sealing mechanism provided on said inflation shaft and engaging said shaft housing for providing a substantially air-tight seal between said inflation shaft and said shaft housing;
a balloon provided in pneumatic communication with said inflation shaft;
a second valve provided in pneumatic communication with said first valve and said inflation shaft for selectively distributing the pressurized air between said first valve and said inflation shaft;
wherein flow of water through the conduit is blocked by attaching said shaft housing to the conduit; distributing the pressurized air from said first valve to said shaft housing by closing said second valve, whereby the pressurized air impinges against said sealing mechanism and sidably displaces said inflation shaft in said shaft housing and advances the balloon into the conduit; opening said second valve, whereby the pressurized air flows from said first valve through said second valve and into said balloon through said inflation shaft and inflates said balloon and said balloon blocks the conduit;
terminating deflation of said balloon by closing said second valve; and
wherein flow of water through the conduit is re-established by deflating said balloon by opening said second valve and releasing the pressurized air from said first valve, whereby water flows from the conduit to said shaft housing and impinges against said sealing mechanism and slides said inflation shaft in said shaft housing and advances the balloon from the conduit.

14. The pressure flow stop of claim 13 comprising a pneumatic hose establishing pneumatic communication between said first valve and said second valve.

15. The pressure flow stop of claim 13 comprising a valve body provided in pneumatic communication with said shaft housing and wherein said first valve is provided in pneumatic communication with said valve body.

16. The pressure flow stop of claim 15 comprising a pneumatic hose establishing pneumatic communication between said first valve and said second valve.

17. The pressure flow stop of claim 13 wherein said sealing mechanism comprises an O-ring collar provided on said inflation shaft and at least one O-ring provided on said O-ring collar.

18. The pressure flow stop of claim 17 comprising a pneumatic hose establishing pneumatic communication between said first valve and said second valve.

19. The pressure flow stop of claim 18 comprising a valve body provided in pneumatic communication with said shaft housing and wherein said first valve is provided in pneumatic communication with said valve body.

20. A method of replacing a water shutoff valve characterized by a valve housing having a water meter coupling attached to a water meter, a water line coupling attached to a water source pipe for receiving a supply of water from a main water line and a valve fitted in the valve housing between the water meter coupling and the water line coupling, said method comprising:
(a). providing a pressure flow stop comprising a first valve for receiving pressurized air; an elongated shaft housing provided in pneumatic communication with said first valve for receiving the pressurized air from said first valve; an elongated inflation shaft slidably disposed in said shaft housing; a second valve provided in pneumatic communication with said first valve and said inflation shaft for selectively distributing the pressed air between said first valve and said inflation shaft; a sealing mechanism provided on said inflation shaft and engaging said shaft housing for providing a substantially air-tight seal between said inflation shaft and said shaft housing; a flexible balloon stem removably and pneumatically coupled to said inflation shaft for receiving the pressurized air from said inflation shaft; a check valve provided on said balloon stem, said check valve disposed in an open configuration when said inflation shaft is coupled to said balloon stem to establish pneumatic communication between said inflation shaft and said balloon stem and said check valve disposed in a closed, air-sealing configuration when said inflation shaft is uncoupled from said balloon stem; and a balloon provided in pneumatic communication with said balloon stem for receiving the pressurized air from said balloon stem;
(b). closing the valve of the water shutoff valve to stop flow of water from the water source pipe to the water meter;
(c). removing the water meter from the water meter coupling of the water shutoff valve;
(d). removably connecting said shaft housing in fluid communication with the water meter coupling of the water shutoff valve;
(e). opening the valve of the water shutoff valve, whereby water flows under pressure from the water source pipe, through the water shutoff valve and into said shaft housing, and said sealing mechanism on said inflation shaft substantially prevents the water from leaking from said shaft housing;
(f). extending said balloon stem from said shaft housing to locate said balloon in the water source pipe by closing said second valve and introducing the pressurized air into said first valve, whereby the pressurized air impinges against said sealing mechanism to slide said inflation shaft in said shaft housing;
(g). inflating said balloon in the water source pipe by opening said second valve to introduce the pressurized air from said first valve into said inflation shaft, whereby said balloon inflates on said balloon stem and substantially obstructs the water source pipe and blocks flow of water from the water source pipe into the valve housing of the water shutoff valve;
(h). terminating inflation of said balloon in the water source pipe by closing said second valve;
(i). detaching said shaft housing from the water meter coupling of the water shutoff valve and uncoupling said inflation shaft from said balloon stem, whereby said check valve closes to prevent deflation of said balloon and said balloon stem extends through the water shutoff valve;
(j). detaching the water shutoff valve from the water source pipe and removing the water shutoff valve from said balloon stem by sliding the water shutoff valve over said balloon stem;
(k). sliding a replacement water shutoff valve on said balloon stem and connecting the replacement water shutoff valve to the water source pipe;
(l). coupling said inflation shaft to said balloon stem, whereby said check valve opens to establish pneumatic communication between said inflation shaft and said balloon stem;
(m). connecting said shaft housing to the water meter coupling of the replacement water shutoff valve;
(n). deflating said balloon in the water source pipe by opening said second valve and operation of said first valve, whereby water from the water source pipe flows through the replacement water shutoff valve and into the shaft housing and impinges against said sealing mechanism to slide said inflation shaft in said shaft housing and retract the balloon from the water source pipe, through the replacement water shutoff valve and into said shaft housing;
(o). closing the valve of the replacement water shutoff valve;
(p). disconnecting said shaft housing from the water meter coupling of the replacement water shutoff valve and connecting the water meter to the water meter coupling of the replacement water shutoff valve; and
(q). opening the valve of the replacement water shutoff valve to re-establish flow of water from the water source pipe to the water meter.
